(19) United States
(12) Patent Application Publication
(10) Pub. No.: US 2022/0101299 A1
(43) Pub. Date: Mar. 31, 2022

(54) SYSTEMS AND METHODS FOR ADAPTING NETWORK MESSAGING

(71) Applicant: MASTERCARD INTERNATIONAL INCORPORATED, Purchase, NY (US)

(72) Inventor: Luis Filipe de Almeida Ferreira da Silva, Bruxelles (BE)

(21) Appl. No.: 17/488,177

(22) Filed: Sep. 28, 2021

Related U.S. Application Data
(60) Provisional application No. 63/084,850, filed on Sep. 29, 2020.

(51) Int. Cl. G06Q 20/32; H04L 29/08; H04L 12/58

(52) U.S. Cl. CPC G06Q 20/325; G06Q 20/3221; H04L 51/28; H04L 67/306

(57) ABSTRACT

Systems and methods are provided for adapting network messaging. One example method includes receiving, by a computing device, input data indicative of a network transaction, where the input data includes a non-conforming account number inconsistent with a standard format for a payment network. The method also includes compiling a network message for the network transaction with a party generic number included in a data element of the network message reserved for a user account number and the non-conforming account number in a different data element of the network message, wherein the party generic number includes a format consistent with the standard format for the payment network, and transmitting the network message to a party associated with the party generic number.

### CROSS-REFERENCE TO RELATED APPLICATION

This application claims the benefit of, and priority to, U.S. Provisional Application No. 63/084,850, filed Sep. 29, 2020. The entire disclosure of the above application is incorporated herein by reference.

### FIELD

The present disclosure generally relates to systems and methods for adapting network messaging, and specifically, to systems and methods for adapting network messaging, for example, based on (and/or to accommodate) input data that is inconsistent with one or more data definitions of the messaging.

### BACKGROUND

This section provides background information related to the present disclosure which is not necessarily prior art.

Users are known to use payment accounts linked to cards to pay for the purchases of different types of products (e.g., goods and services, etc.), from different merchants. In connection therewith, when primary account numbers (PANs) that are associated to the cards are provided to the merchants, for example, as part of transactions for the purchases at the merchants, terminals at the merchants compile and transmit authorization request messages (via the merchants' banks) for the transactions to be processed over card-based payment networks. In doing so, the PANs are assigned to data elements (DEs) in the messages, whereby the card-based payment networks processing the authorization request messages are informed of issuers of the cards linked to such PANs, thereby permitting the payment networks to forward or route the authorization request messages to the appropriate issuers of the cards linked to the accounts used to pay for the purchases. When the transactions are authorized, authorization response messages are provided, from the issuers, back to the merchants, through the card-based payment networks, either approving or declining the transactions. When approved, the transactions are later cleared and settled between the merchants' banks and the issuers. The issuers subsequently debit the accounts of the users, and the merchants' banks subsequently credit the accounts of the merchants.

Similarly, users are known to use payment accounts linked to cards to transfer funds into accounts. In connection therewith, when PANs that are associated to the cards are provided to money transfer operators, for example, as part of fund transfer transactions, terminals at the money transfer operators compile and transmit authorization request messages (via the money transfer operators' banks) for the transactions to be processed over card-based payment networks. The PANs are assigned to DEs in the messages, whereby the card-based payment networks processing the authorization request messages are informed of issuers of the cards linked to such PANs, thereby permitting the payment networks to forward or route the authorization request messages to the appropriate issuers of the cards linked to the accounts to which the funds are intended to be transferred. When the transactions are authorized, authorization response messages are provided, from the issuers, back to the money transfer operators, through the card-based payment networks, either approving or declining the transactions. When approved, the transactions are later cleared and settled between the money transfer operators' banks and the issuers. The issuers subsequently credit the accounts of the users, and the money transfer operators' banks subsequently debit the accounts of the money transfer operators.

### DRAWINGS

The drawings described herein are for illustrative purposes only of selected embodiments and not all possible implementations, and are not intended to limit the scope of the present disclosure.

FIG. 1 is a block diagram of an example system of the present disclosure suitable for use in adapting network messaging, for example, based on (and/or to accommodate) input data that is inconsistent with one or more conventional data definitions of the messaging;

FIG. 2 is a block diagram of an example computing device that may be used in the system of FIG. 1; and

FIG. 3 is a flow diagram of an example method, which may be implemented in connection with the system of FIG. 1, for use in adapting network messaging to include input data that is inconsistent with a data definition of the messaging, whereby an account number (e.g., a non-conforming primary account number (PAN), etc.) is appended to an unused or undefined data element (DE) of the messaging, while a user agnostic number (e.g., a receiving service provider (RSP) PAN, etc.) is included in the DE conventionally reserved for the account number (e.g., a PAN DE, etc.).

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

The present disclosure generally relates to systems and methods for adapting network messaging of a card-based payment network, and specifically, to systems and methods for adapting network messaging of a card-based payment network to allow it to process transactions involving accounts not associated with cards or involving accounts held at financial institutions that are not network participants.

In routing messages between financial institutions, card-based payment networks are often restricted based on formats and/or standards of the messages provided, forwarded and received, etc. In particular, the payment networks are restricted by a data element (DE) of the messaging which is reserved for a primary account number (PAN) that is linked to a payment account to be used to pay for purchases of goods and services or to receive funds in a money transfer. This DE restricts the card-based payment networks in at least two ways. For example, the PAN must comply to a specific format (typically, and as specified in ISO 8583, which is the format used by many card networks, to numeric digits only and only up to 19 total digits). This often prevents card-based networks from offering solutions where the PAN would directly represent the number of a non-card account. For example, bank accounts often use international bank account numbers (IBANs), where the IBANs can have alphabetical characters and can also have more than 19 characters. In addition, the PAN is used by its issuer to identify which account held by the issuer to debit or to credit. This implies that the payment account that is to be used to pay for purchases of goods and services or to receive funds in a money transfer must be held at the institution that is the network participant which the card-based payment network identifies as being the issuer of the card associated with PAN.

Uniquely, the systems and methods herein provide for adapting message format specifications and/or associated usage guidelines of (e.g., and potentially adapting data for transactions to the data definitions of messaging used by, etc.) card-based payment networks, so that the card-based payment networks are able to process transactions involving accounts not associated with cards (or accounts not associated with cards branded with a scheme of that given payment network) or involving accounts held at financial institutions that are not network participants. In addition, the systems and methods herein also facilitate the provision of appropriate reference data to participants in the transactions (e.g., network participates that originate such transactions, etc.) (e.g., identification of appropriate handling parties, identification of appropriate accounts, etc.) so that the participates can appropriately route the transactions to other participants so that the transactions can be accurately processed. In connection therewith, the transactions herein may involve payment transactions by users at merchants; fund transfer transactions between users, between merchants, between users and merchants, etc.; other transactions; etc.

For example, in the context of a money transfer transaction (for a fund transfer) (without limitation) performed via a card-based payment network with adapted message format specifications and/or associated usage guidelines (as generally described herein), a money transfer operator, or as the case may be, its bank, includes a number of an account intended to receive the funds (e.g., a beneficiary account for the transfer in this example, etc.), either represented in an internal format commonly used in the corresponding country from which the transfer transaction originates or as an IBAN, in a special DE (e.g., a beneficiary account number DE, etc.) in a network message requesting the fund transfer. The special DE may be different (e.g., formatted different, a different DE, etc.) from the traditional DE intended to carry the PAN in the message (e.g., where the traditional DE may include DE 2 formatted based on the ISO 8583 standard for card transaction messages (whereby card networks traditionally use DE 2 as being the DE to carry the PAN that represents the beneficiary account), etc.). The traditional DE intended to carry the PAN (e.g., DE 2, etc.), then, is made available by the card-based payment network to transmit a special-purpose PAN (e.g., a receiving service provider (RSP) PAN that satisfies the ISO 8583 standard requirements for a conventional PAN for DE 2 (e.g., includes sixteen digits, etc.), etc.) that specifically identifies the network participant financial institution intended to receive the network message (e.g., the RSP, etc.), instead of identifying the beneficiary account. Thereafter, when the RSP is in receipt of the network message for the fund transfer transaction, the RSP will identify the transaction as a special type based on the presence of the special-purpose PAN (e.g., based on the presence of the RSP PAN, etc.) in the traditional DE intended to carry the PAN (e.g., in DE 2, etc.), whereupon the RSP will then retrieve the beneficiary account number from the special DE of the network message. If the beneficiary account is held at the RSP, the RSP can credit it directly in accordance with the fund transfer. If the beneficiary account is not held at the RSP, the RSP can forward the payment instruction (by using another payment network or by using a correspondent banking agreement) to the financial institution that holds the beneficiary account (which need not be a participant of the card-based payment network processing the underlying fund transfer transaction (and corresponding network request message)).

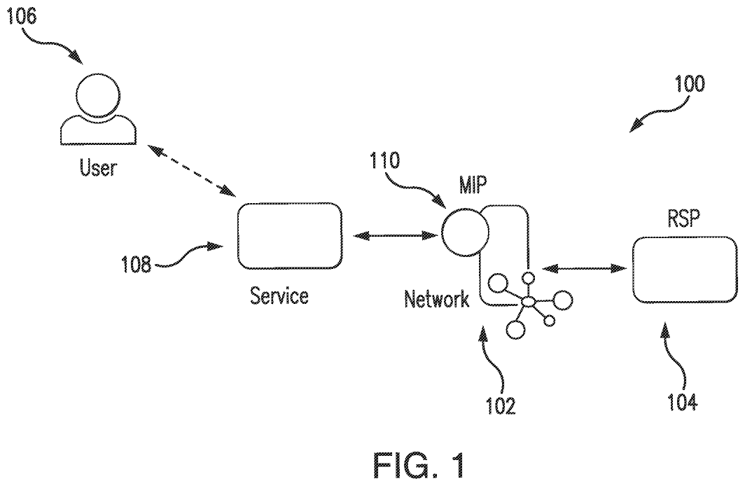

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, services involved in the system, relationships between different parts of the system 100, privacy regulation and/or requirements, etc.

As shown in FIG. 1, the illustrated system 100 generally includes a network 102 and a receiving service provider (RSP) 104, each coupled to (and in communication with) one or more communication network(s), as indicated by arrowed lines. Each of the one or more communication network(s) may each include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this example embodiment, the network 102 includes a payment network, which is configured to coordinate transactions between different entities (e.g., including the RSP 104, etc.), often on behalf of users, including, for example, user 106.

In addition, the RSP 104 includes a banking institution, which is configured to issue accounts to users. In this embodiment, the RSP 104 is configured to issue an account (e.g., a payment account, a checking account, any other desired type of account, etc.) to the user 106. The account is associated with an account number, which may include, generally, any format. For example, the account number may include eight alpha-numeric digits, or another number of digits, etc., as desired by the RSP 104 or as suitable for use by the RSP 104.

The system 100 also includes a service 108, which is associated with fund transfers in this example. The service 108 may be integrated with the network 102, for example, or with another entity shown in FIG. 1, or otherwise. The service 108 may include, for example, the Mastercard Send™ service, which provides for fund transfers from users to other users, from users to businesses, etc. In this example embodiment, the service 108 is configured to expose an application programming interface (API), through which users and/or businesses are permitted to submit fund transfers. The API is defined to receive input data from a user (or business), including, without limitation, account information for his/her account with the RSP 104, amount of transfer, etc. Because the API is specific to the service 108 (and not any particular network messaging), at least in this embodiment, the format of the input data may be unlimited. For example, the account number for an account included in the transfer request (or the user's account number with the RSP 104) may be different than (or non-conforming from) a conventional PAN format for the network 102, as described above (e.g., it may not include sixteen numeric digits, it may be different than a sixteen digit numerical format, etc.).

While the service 108 is described as a fund transfer service, it should be appreciated that the service may be any service, whether associated with and/or included in the network 102, or not, where network messaging (associated with fund transfers) is generated and/or directed to the network 102 in connection with facilitating the service, etc.

Further in the system 100, the network 102 is associated with and/or includes an interface processor, which in this embodiment, includes a Mastercard® interface processor or MIP 110. The MIP 110 is configured to receive input data associated with the service, to compile a fund transfer instruction (e.g., a message for such transfer, etc.) (e.g., for a debit to an identified account, for a withdrawal from an identified account, etc.) and to transmit the transfer instruction to the payment network (e.g., transmit the transfer instruction via the payment rails of the network 102, etc.).

In particular, in this embodiment, the MIP 110 is configured to receive the input data for a fund transfer (broadly, a transaction), via the service 108, from the user 106, in whatever format the service 108 provides the input data (e.g., in whatever format the input data is received from the user 106, etc.). Conventionally, for a payment account, the MIP 110 is configured to include a primary account number (PAN) in a particular data element (DE) of the transfer instruction (e.g., the message for such transfer (e.g., an authorization message, etc.), etc.) reserved for the PAN (broadly, reserved for a user account number) (e.g., where the PAN includes numeric digits only and only up to 19 total digits, etc.) (e.g., a PAN DE, DE 2, etc.). The particular account involved in the transaction (be it a debit or credit transaction), then, can be identified by the recipient of the transfer instruction via the PAN in the particular DE.

However, in this example, because the account number for the user 106 initiating the transaction (as a payment in this example) is inconsistent with the conventional format of a PAN (e.g., is a non-conforming account number inconsistent with a standard format for the network 102, is a non-card account number, etc.), a transfer instruction including the inconsistent account number (populated in the PAN DE) would not conventionally be permitted in the payment network (e.g., it would result in error message(s), etc.). As such, the MIP 110 is configured to include (in compiling the transfer instruction) a special-purpose PAN (e.g., a RSP PAN in this example embodiment, etc.) in the data element reserved for the PAN (the PAN DE (e.g., DE 2 of a message formatted based on the ISO 8583 standard, etc.)) (e.g., identified based on input data received from the service 108 and/or based on a data structure of RSP PANs compiled in response to registration of RSPs with the network 102, etc.). The RSP PAN is specific to the RSP 104 of the user's payment account, but is generic to various user accounts issued by the RSP 104. Stated another way, the RSP PAN does not identify any one payment account (e.g., it is not specific to the user 106, it is not specific to the user's account, etc.). But, in this example, the RSP PAN includes a conventional bank identification number (BIN) for the RSP 104, for reasons described below (e.g., to facilitate identification of the RSP 104, etc.), and also further digits which are not linked to any one specific account (but satisfies a conventional PAN format and still also identifies the RSP 104).

In addition, the MIP 110 is further configured to include (in compiling the transfer instruction) the inconsistent (or non-conforming) account number for the user 106 into another DE of the transfer instruction. The other DE may be unused, or undefined. The MIP 110 is configured to then submit the transfer instruction to the network 102.

In turn, the network 102 is configured to receive the transfer instruction, from the MIP 110, along the conventional payment rails and route the instruction to the RSP 104, based on the BIN included in the RSP PAN. Specifically, the network 102 (as is conventional) is configured to rely on the BIN to identify the RSP 104, and any applicable services associated with the RSP 104 to be applied to the transfer instruction, etc. Upon receipt of the transfer instruction, the RSP 104 is configured to pull the RSP PAN from the DE reserved for the PAN in the transfer instruction, to identify the transaction as special, and then to pull the user's actual account number (in this example) from the other DE of the transfer instruction. The RSP 104 is then configured to handle the transfer (broadly, the transaction) as is conventional, by determining to approve or decline the transfer or to execute the transfer, and then to compile and transmit a confirmation or an authorization reply message (indicating the same) back to the network 102, which is provided back to the service 108. It should be appreciated that, like the MIP 110, the RSP 104 is also configured to include the RSP PAN in the DE reserved for the PAN in generating the reply message, and also the user's actual account number in the other DE of the reply message.

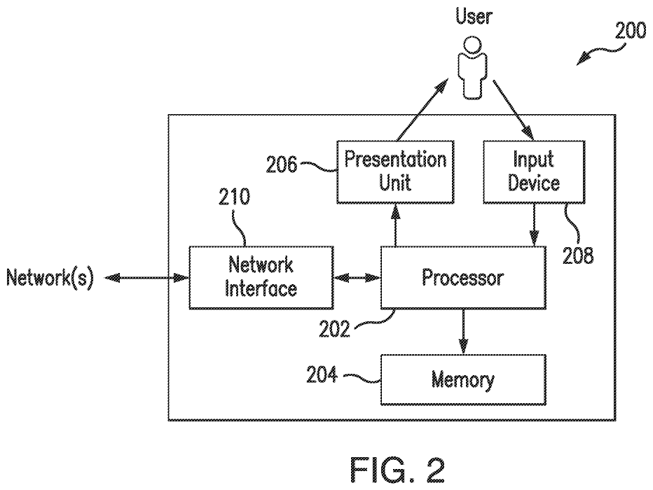

FIG. 2 illustrates an example computing device 200 that may be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the network 102, the RSP 104, the service 108, and the MIP 110 may include, or may be implemented in, a computing device consistent with computing device 200, coupled to (and in communication with) one or more communication network(s) in the system 100 (or otherwise). However, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, RSP PANs (broadly, special-purpose PANs), account numbers, routing rules/tables, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, whereby in connection with performance of such operations the computing device 200 may be transformed into a special purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., confirmations of fund transfers, etc.), visually, for example, to a user of the computing device 200, such as the user 106, etc. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 includes an input device 208 that receives inputs from the user (i.e., user inputs) such as, for example, requests to transfer funds, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. In addition, in various example embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), an RFID reader, a mobile network adapter, or other device capable of communicating to one or more different networks, including the one or more networks.

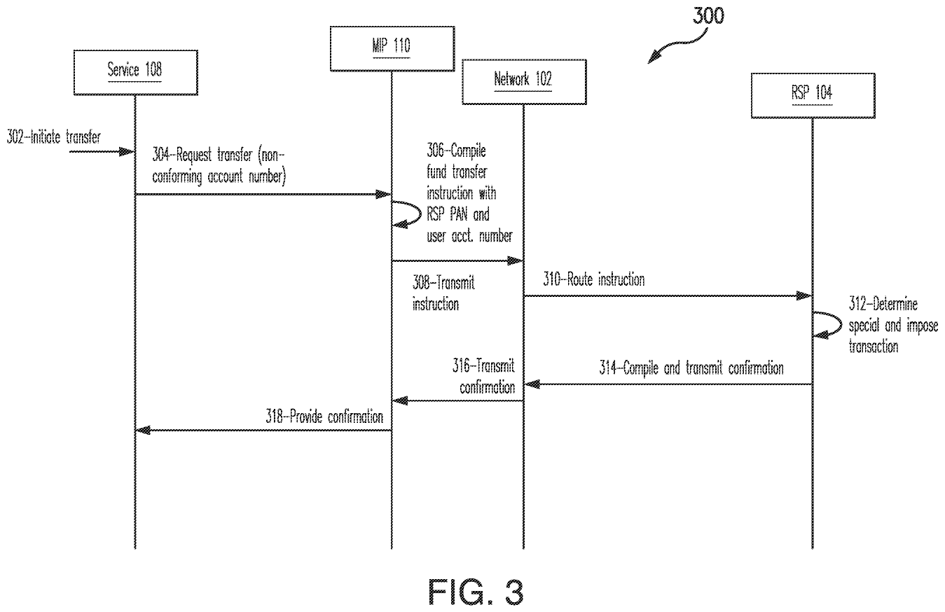

FIG. 3 illustrates an example method 300 for use in adapting network messaging for accommodating input data that is inconsistent with one or more data definitions of the network messaging. The example method 300 is described as implemented in the system 100, with further reference also made to the computing device 200. However, the methods herein should not be understood to be limited to the system 100 or the computing device 200, as the methods may be implemented in other systems and/or computing device. Moreover, the systems and the computing devices herein should not be understood to be limited to the example method 300.

At the outset in this example, it should be appreciated that the network 102 registers one or more RSP PANs (broadly, special-purpose PANs) for each participating RSP institution (including the RSP 104), whereby both the network 102 and the RSP 104, for example, recognize the RSP PAN as indicative of the RSP 104 and also as indicative of the actual account number being included elsewhere in the underlying instruction or authorization message (e.g., whereby both recognize a transaction as being special when the RSP PAN is included in the underlying messaging, etc.). In connection therewith, the participating RSP institution (e.g., RSP 104, etc.) may, without limitation, provide the network 102 with additional reference information about the types and/or ranges of accounts that it is capable of accepting payments for via each RSP PAN and about itself (e.g., name, address, business identifier code (BIC), etc.) (e.g., where the RSP 104 may include different RSP PANs for different types and/or ranges of accounts, etc.). This information, together with the associated RSP PAN, may broadly be referred to as reference information. And, the network 102 stores the reference information in a data structure for subsequence use. The network 102, then, periodically distributes (or pushes) the reference information for all RSP PANs of the various participating RSP institutions to the various participant originating institutions (e.g., the service 108, the MIP 110, other originating institutions (e.g., institutions configured to originate transactions herein, etc.) in communication with the network 102, etc.), so as to enable them to identify and route the transactions to the correct RSPs in a manner that is appropriate.

In addition to the above, the registered RSP PANs are stored in memory (e.g., in memory 204 of the computing device 200 associated with the network 102, the RSP 104, the MIP 110, etc.), and retrieved as described below. And again, as noted above, it should be appreciated that the RSP PANs may be further indicative of other information, whereby the RSP 104, for example, may have multiple RSP PANs, each specific to types of transactions, ranges of services, or further ranges or types of accounts that may be included/involved in the transactions, etc.

Initially in the method 300, the user 106 initiates, at 302, a fund transfer with the service 108. In doing so, the user 106 provides an account number for an account involved in the transfer/transaction. In this example embodiment, the request for the fund transfer is received, via the Mastercard Send™ service, whereby the request is to send funds from the user's account (as a debit action) to another account (broadly, a transaction). It should be appreciated that the request may be received in any form consistent with the specifications and/or requirements of the service 108. For example, the request may be received via an API exposed by the service 108 (whereby the request may be received in a form consistent with the API, etc.). In any case in this example, a format of a number for the user's account number associated with the request is not consistent with a conventional PAN format (e.g., it is a non-conforming account number, etc.).

The service 108, in turn, provides, at 304, details of the fund transfer to the MIP 110 of the network 102 (e.g., in the form received from the user 106, etc.). It should be appreciated further, in at least some embodiments, that the service 108 may be omitted, whereby the user 106 (a person or a banking institution, for example) may submit the request directly to the MIP 110.

In turn, the MIP 110 compiles, at 306, a fund transfer instruction (or message) for the fund transfer (e.g., an authorization request message, etc.). In doing so, the MIP 110 recognizes that the fund transfer involves a non-conforming account number (for the user 106. As such, the fund transfer instruction includes the RSP PAN for the RSP 104 (e.g., as recognized by the MIP 110 based on the actual account number provided by the user 106, etc.) and also the account number of the user's account (as received from the service 108 or the user 106 directly) (as well as other information necessary for the transfer, for example, an account number for the account to receiving the funds, and amount of the transfer, etc.). For instance, in compiling the request, the MIP 110 may look up or retrieve the RSP PAN from memory (based on the RSP 104 and registration thereof with the network 102, based on reference information for the RSP 104 pushed by the network 102 to the MIP 110, etc.), etc. The transfer instruction is then compiled and configured, by the MIP 110, in this example, consistent with the ISO 8583 format. Table 1 illustrates an example of various different data elements (DE) of the instruction (and consistent with the ISO 8583 format). For instance, in this example, the RSP PAN is included in DE 2, and the account number for the user is included in DE XX, which may be any suitable unused or unassigned data element (e.g., sufficiently size to receive the account number, etc.). It should also be appreciated that additional data elements may be included/utilized in the transfer instruction or network message or authorization message as needed to accommodate other data (e.g., other reference information associated with the fund transfer, etc.).

TABLE 1

| Data Element (DE) | Instruction Message Content |
|---|---|
| DE 2 | RSP PAN |
| DE XX | User's Account number |
| (suitable unused or | |
| unassigned DE) | |

Next in the method 300, the MIP 110 transmits, at 308, the transfer instruction to the network 102. The network 102 then pulls the RSP PAN from the DE reserved for the conventional PAN (e.g., DE 2 in the above example, etc.), from the transfer instruction, and identifies the RSP 104 (e.g., based on the BIN of the RSP PAN, etc.), and then routes, at 310, the transfer instruction to the RSP 104.

Upon receipt of the instruction, at 312, the RSP 104 determines that the instruction is special based on the inclusion of the RSP PAN (e.g., a PAN formatted number that is non-specific to any one account but that identifies the RSP 104, etc.) being included at the DE reserved for the conventional PAN. Thereafter, the RSP 104 pulls the actual account number from the instruction at the other DE (e.g., DE XX in the above example, etc.), and executes the transaction based thereon. The RSP 104 then compiles and transmits, at 314, a confirmation message to the network 102. The confirmation message, like the transfer instruction, includes the RSP PAN in the DE reserved for the PAN (e.g., DE 2 in the above example, etc.) and the account number of the user's account in another DE (e.g., DE XX in the above example, etc.).

The network 102 transmits the confirmation message to the MIP 110, at 316, which provides the confirmation message to the service 108 (or the user 106), at 318. And, in turn, the service 108 provides the confirmation message to the user 106 (if not directly received from the MIP 110).

Notwithstanding the above, it should be appreciated that the account number to be debited/credited in connection with a fund transfer (or other transaction) may be held by an institution other than the RSP 104. In such examples, though, the RSP 104 may act as an intermediate to facilitate the transfer (whereby the RSP PAN for the RSP 104 is still utilized in the transfer instruction). As such, upon receiving the transfer instruction, the RSP 104 may then forward the instruction to the institution where the account is held (e.g., based on a look-up table at the RSP 104, etc.).

In a further example, an originating institution may effect a transaction over the network 102, consistent with the above, where the originating institution codes in a special PAN for a receiving institution to which the originating institution intends to send the transaction instruction, in a data element of the transaction message conventionally reserved for the PAN (e.g., in the PAN DE, etc.) (independent of the service 108, MIP 110, etc.). The originating institution also codes in an actual account number to be debited or credited in another data element of the transaction message (whereby the actual account number does not need to be a card account number or otherwise consistent with a conventional PAN). And, the originating institution then codes the other data elements (or message fields) of the transaction message as appropriate to facilitate the transaction.

Next, the receiving institution that receives the transaction message identifies the message as requiring special processing by means of the special PAN for the receiving institution (to which the message is addressed or directed). Upon receiving the transaction message, the receiving institution retrieves the actual account number from the other data element of the message and debits or credits (as appropriate) the corresponding account.

In view of the above, the systems and methods herein allow for conventional messaging standards and rails (e.g., conventional payment network messaging, conventional payment network rails, etc.) to be utilized to facilitate transactions to/from accounts involving non-standard account numbers. In particular, the systems and methods herein adapt conventional message format specifications and/or associated usage guidelines of card-based payment networks, so that the card-based payment networks are able to process the transactions involving the accounts. And, in doing so, the systems and methods herein also facilitate the provision of appropriate reference data to participants in the transactions so that the participates can properly route the transactions to other participants and so that the other participants can accurately process the transactions.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving input data indicative of a network transaction, the input data including a non-conforming account number inconsistent with a standard format for a payment network, the non-conforming account number specific to a user; (b) compiling a network message for the network transaction with a party specific number included in a data element of the network message reserved for a user account number and the non-conforming account number in a different data element of the network message, wherein the party specific number is not specific to the user, wherein the party specific number includes a format consistent with the standard format for the payment network; and (c) transmitting the network message to a party associated with the party specific number.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” as well as the phrase “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for adapting network messaging based on input data that is inconsistent with one or more data definitions of the network messaging, the method comprising:
receiving, by a computing device, input data indicative of a network transaction, the input data including a non-conforming account number inconsistent with a standard format for a payment network, the non-conforming account number specific to a user;
compiling a network message for the network transaction with a party specific number included in a data element of the network message reserved for a user account number and the non-conforming account number included in a different data element of the network message, wherein the party specific number is not specific to the user, and wherein the party specific number includes a format consistent with the standard format for the payment network; and
transmitting, by the computing device, the network message to a party associated with the party specific number.

2. The computer-implemented method of claim 1, wherein the party includes a receiving service provider (RSP);
wherein the party specific number includes a number specific to the RSP; and
wherein the non-conforming account number includes a bank account number.

3. The computer-implemented method of claim 2, wherein the party specific number is not specific to an account of the user associated with the non-conforming account number.

4. The computer-implemented method of claim 2, wherein receiving the input data includes receiving the input data via an application programming interface associated with a fund transfer service of the payment network.

5. The computer-implemented method of claim 2, further comprising, prior to receiving the input data indicative of the network transaction, registering the RSP to the payment network and storing the party specific number in association with the RSP in a data structure in communication with the computing device.

6. The computer-implemented method of claim 5, wherein registering the RSP to the payment network includes receiving, from the RSP, reference information relating to the RSP, the reference information including one or more of a name of the RSP, an address of the RSP, and/or at least one type of account for which the RSP is capable of accepting payment.

7. The computer-implemented method of claim 6, further comprising distributing the reference information relating to the RSP to one or more parties in communication with the payment network, whereby the reference information is available for use by the one or more parties to initiate network transactions involving accounts issued by the RSP.

8. The computer-implemented method of claim 1, wherein the computing device includes an interface processor.

9. A non-transitory computer-readable storage medium comprising executable instructions for use in adapting network messaging, which when executed by at least one processor, cause the at least one processor to:
receive input data indicative of a network transaction, the input data including a non-conforming account number inconsistent with a standard format for a payment network, the non-conforming account number specific to a user;
compile a network message for the network transaction with a party specific number included in a data element of the network message reserved for a user account number and the non-conforming account number included in a different data element of the network message, wherein the party specific number is not specific to the user, wherein the party specific number includes a format consistent with the standard format for the payment network; and
transmit the network message to a party associated with the party specific number.

10. The non-transitory computer-readable storage medium of claim 9, wherein the party includes a receiving service provider (RSP);
wherein the party specific number includes a number specific to the RSP; and
wherein the non-conforming account number includes a bank account number.

11. The non-transitory computer-readable storage medium of claim 10, wherein the executable instructions, when executed by the at least one processor in order to receive the input data, cause the at least one processor to receive the input data via an application programming interface associated with a fund transfer service of the payment network.

12. The non-transitory computer-readable storage medium of claim 11, wherein the executable instructions, when executed by the at least one processor, further cause the at least one processor to register the RSP and store the party specific number in association with the RSP in a data structure in communication with the at least one processor.

13. The non-transitory computer-readable storage medium of claim 12, wherein the executable instructions, when executed by the at least one processor in order to register the RSP, cause the at least one processor to receive, from the RSP, reference information relating to the RSP, the reference information including one or more of a name of the RSP, an address of the RSP, and/or at least one type of account for which the RSP is capable of accepting payment.

14. The non-transitory computer-readable storage medium of claim 13, wherein the executable instructions, when executed by the at least one processor, further cause the at least one processor to distribute the reference information relating to the RSP to one or more parties in communication with the payment network, whereby the reference information is available for use by the one or more parties to initiate network transactions involving accounts issued by the RSP.

15. A system for use in adapting network messaging based on input data that is inconsistent with one or more data definitions of the network messaging, the system comprising a payment network including an interface processor, the interface processor configured to:
receive input data indicative of a network transaction, the input data including a non-conforming account number inconsistent with a standard format for a payment network, the non-conforming account number specific to a user;
compile a network message for the network transaction with a party specific number included in a data element of the network message reserved for a user account number and the non-conforming account number in a different data element of the network message, wherein the party specific number is not specific to the user, wherein the party specific number includes a format consistent with the standard format for the payment network; and
transmit the network message to a party associated with the party specific number.

16. The system of claim 15, wherein the party includes a receiving service provider (RSP);
wherein the party specific number includes a number specific to the RSP; and
wherein the non-conforming account number includes a bank account number.

17. The system of claim 16, wherein the interface processor is configured, in order to receive the input data, to receive the input data via an application programming interface associated with a fund transfer service of the payment network.

18. The system of claim 15, wherein the payment network includes a payment network computing device in communication with the interface processor, the payment network computing device configured to register the RSP and store the party specific number in association with the RSP in a data structure in communication with the at payment network computing device and/or the interface processor.

19. The system of claim 18, wherein the payment network computing device is configured, in order to register the RSP, to receive, from the RSP, reference information relating to the RSP, the reference information including one or more of a name of the RSP, an address of the RSP, and/or at least one type of account for which the RSP is capable of accepting payment.

20. The system of claim 19, wherein the payment network computing device is further configured to distribute the reference information relating to the RSP to one or more parties in communication with the payment network, whereby the reference information is available for use by the one or more parties to initiate network transactions involving accounts issued by the RSP.
